(19) United States
(12) Patent Application Publication
(10) Pub. No.: US 2024/0375128 A1
(43) Pub. Date: Nov. 14, 2024

(54) HAND SHOWER WITH POWER WASH

(71) Applicant: AS America, Inc., Piscataway, NJ (US)

(72) Inventors: Jean-Jacques L'HENAFF, New Canaan, CT (US); Jacob NITZ, London (GB); Paul FLOWERS, London (GB); Greg REINECKER, Brooklyn, NY (US)

(73) Assignee: AS America, Inc., Piscataway, NJ (US)

(21) Appl. No.: 18/690,586

(22) PCT Filed: Sep. 9, 2022
(86) PCT No.: PCT/US2022/076222

§ 371 Date: Mar. 8, 2024

Related U.S. Application Data
(60) Provisional application No. 63/243,386, filed on Sep. 13, 2021.

(51) Int. Cl. B05B 1/16; B05B 1/04; B05B 1/18; E03C 1/04

(52) U.S. Cl. CPC B05B 1/16; B05B 1/042; B05B 1/18; E03C 1/0409

(57) ABSTRACT

A hand shower can include: an inlet portion for connecting the hand shower to a water supply; a handle portion; a shower head portion attached to the handle portion, the shower head portion comprising a shower face, a back face opposite the shower face, and an edge face on an end portion of the shower head portion that extends from the shower face to the back face and is opposite the inlet portion; a first outlet portion of the shower head located on the shower face, the first outlet portion is configured to direct a shower spray in a first direction; and a second outlet portion of the shower head located on the edge face, the second outlet portion is configured to direct a power wash spray in a second direction different from the first direction for cleaning hard surfaces.

### CROSS-REFERENCE TO RELATED APPLICATIONS

This application claims the priority benefit of U.S. Provisional Patent Application No. 63/243,386, filed Sep. 13, 2021, the entire contents of which are hereby incorporated by reference herein.

### FIELD

This disclosure generally relates to hand showers and more specifically to hand showers for bathing and power washing.

### BACKGROUND

A hand shower allows a user to move the hand shower to direct a spray about a body or item to be cleaned. A user looking to use the hand shower to clean hard surfaces such as a tub or tile would move the hand shower to spray the hard surface. However, build-up on a hard surface can be difficult to remove with water pressure used for bathing, in which case a user has to manually scrub the hard surface in addition to spraying the hard surface. Therefore, using a hand shower to clean hard surfaces can be a lengthy and difficult process.

### SUMMARY

According to some embodiments, a hand shower includes a handle portion for a user to grip and a shower head portion that includes a first outlet portion configured to deliver a spray suitable for bathing in a first direction and a second outlet portion configured to deliver a spray suitable for power washing in a second direction different from the first direction. That is, the second outlet portion is configured to face a different direction and deliver a different spray type compared to the first outlet portion. The second outlet portion is positioned at an end portion of the shower head portion to allow a user to more accurately aim the spray for targeted power washing. By configuring the hand shower in this way, a user may use the hand shower to deliver a spray type from the first outlet portion and deliver a different spray type from the second outlet.

According to some embodiments, a hand shower comprising: an inlet portion for connecting the hand shower to a water supply; a handle portion; a shower head portion attached to the handle portion, the shower head portion comprising a shower face, a back face opposite the shower face, and an edge face on an end portion of the shower head portion that extends from the shower face to the back face and is opposite the inlet portion; a first outlet portion of the shower head located on the shower face, the first outlet portion is configured to direct a shower spray in a first direction; and a second outlet portion of the shower head located on the edge face, the second outlet portion is configured to direct a power wash spray in a second direction different from the first direction for cleaning hard surfaces.

In any of these embodiments, the end portion may comprise a furthermost end of the shower head portion relative to the handle portion.

In any of these embodiments, the hand shower may be configured to deliver 20% to 50% more water pressure across the edge face in a power wash mode compared to water pressure across the shower face in a shower mode.

In any of these embodiments, the shower head portion may be cylindrical.

In any of these embodiments, the edge face may comprise a length of about 5 mm to about 50 mm.

In any of these embodiments, the shower face may comprise a length of about 50 mm to about 120 mm and a width of about 10 mm to about 60 mm.

In any of these embodiments, the handle portion may be cylindrical.

In any of these embodiments, the shower head portion and the handle portion may share a longitudinal axis throughout the hand shower.

In any of these embodiments, the edge face may be rounded.

In any of these embodiments, the shower head portion may have a larger cross-sectional area than the handle portion.

In any of these embodiments, the first outlet portion may comprise a plurality of first nozzles and the second outlet portion comprises one or more second nozzles.

In any of these embodiments, the one or more second nozzles may comprise blade nozzles configured to deliver the power wash spray with a linear sheet-like flow spray pattern.

In any of these embodiments, the one or more first nozzles may comprise a first set of first nozzles that may comprise a first shape and a first size, and a second set of first nozzles that may comprise a second shape and a second size different from the first shape and the first size.

In any of these embodiments, the hand shower may be configured to deliver the shower spray or the power wash spray based on actuation of a user-activated actuator.

In any of these embodiments, the user-activated actuator may be configured to open or block one or more water passageways to the first outlet portion or the second outlet portion for delivering the power wash spray or the shower spray.

In any of these embodiments, the user-activated actuator may comprise a capacitive touch sensor.

In any of these embodiments, the user-activated actuator may comprise a push button.

In any of these embodiments, the user-activated actuator may be positioned on the handle portion.

In any of these embodiments, the second direction may be angled between about 45 to about 135 degrees relative to first direction.

In any of these embodiments, water pressure of the shower spray may be from about 45 psi to about 80 psi based on a water supply pressure of about 30 psi to about 80 psi.

### BRIEF DESCRIPTION OF THE DRAWINGS

The disclosure will now be described, by way of example only, with reference to the accompanying drawings, in which:

FIG. 1 shows an exemplary hand shower, according to some embodiments;

FIG. 2A shows a schematic of an edge view of an exemplary shower head portion that includes an outlet portion having a single nozzle, according to some embodiments;

FIG. 2B shows a schematic of an edge view of an exemplary shower head portion that includes an outlet portion having more than one nozzle, according to some embodiments;

FIG. 2C shows a schematic of an edge view of an exemplary shower head portion that includes an outlet portion having different nozzles, according to some embodiments;

FIG. 2D shows a schematic of an edge view of an exemplary shower head portion that includes an outlet portion having a plurality of nozzles, according to some embodiments;

FIG. 3A shows a side view of an exemplary hand shower, according to some embodiments;

FIG. 3B shows a front view and four exemplary cross-sectional views of an exemplary hand shower, according to some embodiments;

FIG. 4A illustrates a bottom view of an exemplary hand shower that shows a difference in shape between a handle portion and a hand shower portion, according to some embodiments; and

FIG. 4B shows a top view of an exemplary hand shower, according to some embodiments.

### DETAILED DESCRIPTION

According to some embodiments, a hand shower includes a handle portion and a shower head portion that includes a first outlet on a shower face of the shower head portion for bathing and a second outlet on an edge face of the shower head portion for directed power washing. The edge face is located at an end portion of the hand shower to enable a user to aim the hand shower at an area to be cleaned. The handle portion is sized for user comfort and the shower head portion is sized for achieving water coverage and pressure suitable for a shower mode and a power wash mode. The shower mode may be used for delivering water coverage and pressure that would be comfortable against a user's body. The power wash mode may be used for delivering water coverage and pressure that would be effective to loosen or remove build-up (such as mold, dirt, mildew, soap scum) from hard surfaces (such as tub or tile).

According to some embodiments, the shower head portion is wider than the handle portion to provide room on the shower head portion for the outlet portions located at different positons on the shower head portion. For example, the shower head portion may have a larger cross-sectional area than a cross-sectional area of the handle portion. According to some embodiments, the shower head portion may have a more elongated cross-sectional area that a cross-sectional area of the handle portion. In this way, the shower head portion may be configured to accommodate different sized faces of the shower head portion-each of which may be configured to deliver a different spray characteristics suitable for either showering or power washing.

According to some embodiments, an area of the shower face is larger than an area of the edge face. Compared to the edge face, the larger area of the shower face provides a larger water coverage and suitable water pressure across the larger area for bathing. Compared to the shower face, the smaller area of the edge face provides a smaller water coverage and higher water pressure across the smaller area for targeted power washing. By configuring the shower face and edge face in this way, the shower face can provide water coverage across the larger area delivering water pressure suitable for bathing and the edge face can provide water coverage across the smaller area delivering water pressure suitable for power washing hard surfaces.

According some embodiments, dimensions of the shower face may have a length of at least about 50 mm, about 60 mm, or about 70 mm. According some embodiments, dimensions of the shower face may have a length of at most about 120 mm, about 100 mm, or about 90 mm. According some embodiments, dimensions of the shower face may have a length of about 50 mm to about 120 mm, about 60 mm to about 100 mm, or about 70 mm to about 90 mm. According some embodiments, dimensions of the shower face may have a width of at least about 10 mm, about 15 mm, or about 20 mm. According some embodiments, dimensions of the shower face may have a width of at most about 60 mm, about 50 mm, or about 40 mm. According some embodiments, dimensions of the shower face may have a width of about 10 mm to about 60 mm, about 15 mm to about 50 mm, or about 20 mm to about 40 mm. According to some embodiments, the dimensions of the shower face may include a length of about 50 mm to about 120 mm and a width of about 10 mm to about 60 mm.

According to some embodiments, dimensions of the edge face may have a length of at least about 5 mm, about 10 mm, or about 12 mm. According to some embodiments, dimensions of the edge face may have a length of at most about 50 mm, about 40 mm, or about 30 mm. According to some embodiments, dimensions of the edge face may have a length of about 5 mm to about 50 mm, about 10 mm to about 40 mm, or about 12 mm to about 30 mm. According to some embodiments, dimensions of the edge face may have a width of at least about 0.5 mm, about 1 mm, or about 1.5 mm. According to some embodiments, dimensions of the edge face may have a width of at most about 15 mm, about 10 mm, or about 5 mm. According to some embodiments, dimensions of the edge face may have a width of about 0.5 mm to about 15 mm, about 1 mm to about 10 mm, or about 1.5 mm to about 5 mm. According to some embodiments, dimensions of the edge face may have a length of about 5 mm to about 50 mm and a width of about 10 mm to about 60 mm.

According to some embodiments, the shower face can be configured to face a first direction and the edge face can configured to face a second direction that is different from the first direction. According to some embodiments, the second direction can form an angle between 45 to 135 degrees with respect to the first direction. According to some embodiments, the first direction and the second directions can be perpendicular to each other.

According to some embodiments, the hand shower can be shaped such that the shower face is either curved or flat and the edge face is either rounded or flat. According to some embodiments, an overall shape of the hand shower may be cylindrical. According to some embodiments, the overall shape of the hand shower can be elliptical cylindrical, rectangular cylindrical, or circular cylindrical. According to some embodiments, the overall shape allows a user to position their hand on the handle portion, shower head portion, or at position in which a user hand extends on both portions. For example, a user may position their hand on the handle portion when the hand shower is configured to deliver a shower spray and a user may position their hand at an edge of the shower head portion opposite the handle portion when the hand shower is configured to deliver power wash spray. In this way, the overall shape of the hand shower provides a user flexibility to adjust hand positioning along a longitudinal axis of the hand shower as needed to aim the shower spray or the power wash spray at a target.

According to some embodiments, a shower mode may be configured to deliver the shower spray through the first outlet portion at a water pressure between about 45 and about 80 psi based on household water line supply pressures of about 30 psi to about 80 psi. According to some embodiments, the first outlet portion may span across at the shower face such that the shower spray that exits the first outlet portion has an overall shower spray coverage based on the shower face dimensions described above. According to some embodiments, the first outlet portion can include a plurality of first nozzles and each first nozzle is configured to contribute to the overall shower spray coverage. The plurality of first nozzles can include sets of nozzles arranged across the shower face. Each set may be configured for delivering a shower spray that has a water pressure between about 30 psi to about 100 psi. According to some embodiments, a first set of nozzles may include a first shape and a first size and a second set of nozzle may include a second shape and a second size. The first shape and the second shape may be different or the same and the first size and the second size may be different or the same for targeting a shower pattern and type of shower delivery.

According to some embodiments, a power wash mode is configured to deliver the power wash spray at a higher water pressure compared to water pressure of the shower mode. According to some embodiments, the power wash mode is configured to deliver about 10% to about 50% more water pressure compared to water pressure of the shower mode. According to some embodiments, the power wash mode is configured to deliver about 15% to about 40% more water pressure compared to water pressure of the shower mode. According to some embodiments, the power wash mode is configured to deliver about 20% to about 30% more water pressure compared to water pressure of the shower mode.

According to some embodiments, the second outlet portion may span across at the edge face such that the power wash spray that exits the second outlet portion has an overall power wash spray coverage based on the edge face dimensions described above. Delivering the power wash spray through the second outlet portion positioned on the edge face of the hand shower allows a user to directly aim the power wash spray with a linear spray pattern at a target with a comfortable hand grip on the handle portion. According to some embodiments, the linear spray pattern can be directed along an axis that is parallel with the handle portion of the hand shower. According to some embodiments, the linear spray pattern can be collinear with the longitudinal axis. According to some embodiments, the second outlet portion can include a single blade nozzle configured to deliver a power wash spray that has a sheet-like flow. According to some embodiments, the second outlet portion can include a plurality of blade nozzles for achieving the power wash spray. According to some embodiments, each blade nozzle is configured to deliver a power wash spray that has a sheet-like flow that contributes to the overall power wash coverage. Water pressure delivered from each blade nozzle may be about 10% to about 50% larger compared to water pressure deliverable from each first nozzle of the first outlet portion.

According to some embodiments, a user may switch between the shower mode and the power wash mode via a user-activated actuator. According to some embodiments, the user-activated actuator may be configured to open or block one or more fluid passageways leading to the first outlet portion or the second outlet portion. The user-activated actuator may be located in the handle portion, the shower head portion, or therebetween. According to some embodiments, the user-activated actuator may be a capacitive touch sensor. According to some embodiments, the user-activated actuator can include a push button.

According to some embodiments, the actuator may be configured to cause a diverter mechanism to divert flow from the first outlet to the second outlet and from the second outlet to the first outlet. According to some embodiments, if the power wash mode is activated and water is shut off, the diverter mechanism may be configured to automatically revert to a default position in which water is directed to the first outlet for enabling the shower mode. In this way, when water is turned back on, the shower mode is enabled as opposed to the power wash mode for user convenience and safety.

In addition, it is also to be understood that the singular forms “a”, “an,” and “the” used in the following description are intended to include the plural forms as well, unless the context clearly indicates otherwise. It is also to be understood that the term “and/or,” as used herein, refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units, but do not preclude the presence or addition of one or more other features, integers, steps, operations, elements, components, units, and/or groups thereof.

In the following description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure.

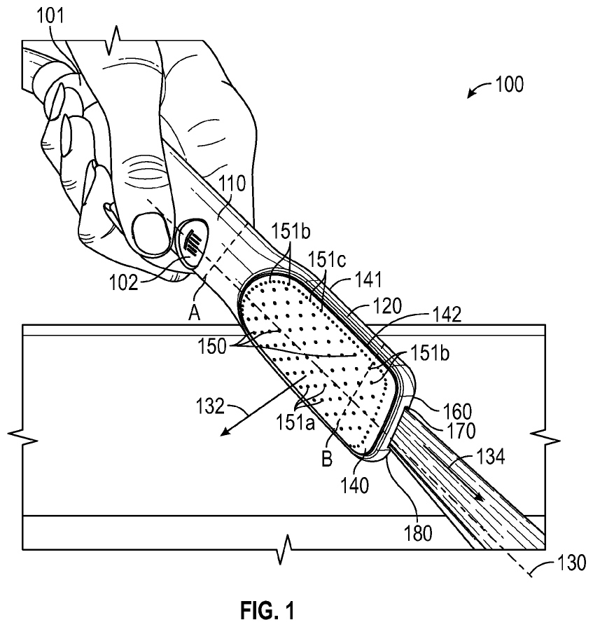

FIG. 1 shows an exemplary hand shower, according to some embodiments. The hand shower can be used to deliver a shower spray suitable for bathing and a power wash spray suitable for power washing hard surfaces (such as tub or tile). According to some embodiments, the shower spray may be delivered from a side face (also referred to as a shower face) towards a first direction and the power wash spray may be delivered from an edge face towards a second direction different from the first direction. The spray pattern of the shower spray and the power wash spray can be different based on a shape and size of nozzles configured to deliver each spray type. According to some embodiments, shower face and the edge faces are located at different portions on the shower head portion. Compared to the edge face, the shower face can be located at a portion of the shower head portion that has a larger area. According to some embodiments, the edge face can be located at an end portion of the hand shower such that the power wash spray can be easily aimed with a longitudinal axis of the hand shower. By configuring the edge face at the end of the hand shower, a user can target an area to be cleaned with the longitudinal axis of the hand shower by simply pointing the longitudinal axis of the hand shower at the area to be cleaned—allowing for directed power washing.

In the example of FIG. 1, the hand shower 100 has an overall shape formed by a handle portion 110 and a shower head portion 120 attached to the handle portion 110. According to some embodiments, the shower head portion 120 can extend from the handle portion 110 such that the shower head portion 120 and the handle portion 110 share a common longitudinal axis 130. In this way, the hand shower 100 can have an overall sleek linear shape throughout. The linear sleek shape can be configured to deliver water from a water supply inlet portion 101 of the handle portion 110 to at least one outlet portion of the shower head portion 120. According to some embodiments, all edges of the hand shower 100 can be rounded to provide transitions between different faces of the hand shower 100 that look and feel smooth to prevent injury during use. According to some embodiments, and as described further below, the shape of the shower head portion provides an optimum spray pattern from a shower face 140 and an optimum spray pattern from an edge face 160.

According to some embodiments, one or more of the handle portion 110 and the shower head portion 120 can have a cylindrical cross-section, such as an elliptical cylindrical cross-section, a rectangular cylindrical cross-section, or a circular cylindrical cross-section configured for user comfort and optimum spray pattern. According to some embodiments, the handle portion 110 is configured to provide a user with a grip of the hand shower. According to some embodiments, the handle portion 110 provides an ergonomically shaped handle portion. According to some embodiments, a cross-sectional area of the shower head portion 120 can be larger than a cross-sectional area of the handle portion 110 to provide larger surface areas at the shower head portion 120 from which a spray may exit. As shown in the example of FIG. 1, the handle portion 110 has a cross-sectional area indicated by dashed line A and the shower head portion 120 has a cross-sectional area indicated by dashed line B. The cross-sectional area of the shower head portion 120 (line B) is larger than the cross-sectional area of the handle portion 110 (line A). That is, the cross-sectional area of the hand shower 100 increases from the handle portion 110 to the shower head portion 120 along the longitudinal axis 130. The larger cross-sectional area of the shower head portion 120 compared to the handle portion 110 allows the shower head portion 120 to have an exterior area suitable for delivering two different spray types in two different directions.

According to some embodiments, the hand shower 100 is configured to deliver at least two different spray types in two different directions. For example a first spray type may be directed to pass through a first outlet portion of the shower head portion in a first direction and a second spray type may be directed to pass through a second outlet portion of the shower head portion in a second direction. According to some embodiments, the different directions are different relative to the longitudinal axis 130. FIG. 1 show an example of a first direction 132 and second direction 134 indicated by arrows. According to some embodiments, the first direction may be about 45 degrees to about 135 degrees downward relative the longitudinal axis 130. According to some embodiments, the first direction may about 60 degrees to about 120 degrees downward relative the longitudinal axis 130. According to some embodiments, the first direction may about 80 degrees to about 100 degrees downward relative the longitudinal axis 130. According to some embodiments, the second direction may be up to about 45 degrees downward or upward relative to the longitudinal axis 130. According to some embodiments, the second direction may be up to about 30 degrees downward or upward relative to the longitudinal axis 130. According to some embodiments, the second direction may be up to about 15 degrees downward or upward relative to the longitudinal axis 130. According to some embodiments, the second direction may be up parallel to the longitudinal axis 130.

According to some embodiments, the shower head portion 120 can include a shower face 140 configured to deliver a shower spray suitable for bathing. In the example of FIG. 1, the shower face 140 is opposite a back face 141 of the shower head portion 120. A shower spray suitable for bathing may have water pressure from about 45 to about 80 psi based on a household water supply pressure of about 30 psi to about 80 psi. The shower face 120 may have dimensions that include a length of about 50 mm to about 120 mm and a width of about 10 mm to about 60 mm.

According to some embodiments, the shower head portion 120 includes a first outlet portion 150 that includes a plurality of first nozzles 151 (such as nozzles 151a, 151b, 151c, 151d) configured to deliver a shower spray suitable for bathing. According to some embodiments, the plurality of first nozzles 151 can include different sets of nozzles. Each set of nozzles can have a different shape, size, or arrangement pattern on the shower face 140 compared to another set of nozzles. For example, the plurality of first nozzles 151 can include one or more of: a first set of first nozzles 151a arranged across a majority of an area of the shower face 140, a second set of first nozzles 151b arranged about a longitudinal periphery of the shower face 140, and a third set of first nozzles 151c arranged about a remaining periphery of the shower face 140. According to some embodiments, the shower face 140 can include a periphery 142 configured to distinguish the shower face 140 from the rest of the shower head portion 120.

The shower head portion 120 can include an edge face 160 that includes a second outlet portion 170 configured to deliver a power wash spray suitable for cleaning hard surfaces. Hard surfaces may include, for example a tub or tile. According to some embodiments, the shape of the hand shower 100 can be configured to allow a user to grip that hand shower 100 at any portion, such as the handle portion 110 or the shower head portion 120, as needed to grip the hand shower and aim the edge face 160 for directed power washing. For example, the user may grip the shower head portion 120 at the edge face 160 to efficiently direct the power wash spray when the hand shower 100 is configured to deliver the power wash spray. A power wash spray suitable for cleaning hard surfaces may have about a 10% to about a 50% larger water pressure compared to water pressure of the shower spray. The edge face 160 may be positioned on an end portion 180 of the shower head 120 opposite the inlet portion 101 of the handle portion 110, as shown in FIG. 1. The end portion 180 of the shower head 120 can be a furthermost end of the shower head 120 relative to the handle portion 110. According to some embodiments, the edge face 160 may have dimensions that include a length of about 5 mm to about 50 mm and a width of about 10 mm to about 60 mm. According to some embodiments, edge face 160 is rounded to prevent injury during use of the hand shower 100.

According to some embodiments, the second outlet portion 170 can be positioned on the edge face 160 such that the power wash spray configured to exit the second outlet portion 170 does not flow across or over the shower head 120 after it exits the second outlet portion. That is, the second outlet portion 170 is positioned such that the power wash spray is directed away from the shower head 120. By configuring the shower head in this way, the power wash spray is less likely to have a spray pattern disrupted by exterior parts of the shower head portion and less likely to wet an exterior (such as a back side 141 that is opposite to the shower face 140) of the shower head 120 compared to an outlet portion positioned on the back side 141.

According to some embodiments, the second outlet portion 170 can include one or more second nozzles. The second nozzles can be blade nozzles configured to deliver a linear sheet-like spray pattern. According to some embodiments, a blade nozzle can be made from either a single nozzle or a plurality of nozzles configured in a linear pattern to form a spray that has a sheet-like pattern across the linear pattern. According to some embodiments, the second outlet portion can include one or more second nozzles, each of which is configured to deliver a spray that contributes to spray coverage of the power wash spray.

According to some embodiments, the hand shower can include a user-activated actuator 102 for configuring the hand shower to deliver the shower spay through the shower face 140 or the power wash spray through the edge face 160. The user-activated actuator 102 may include a capacitive touch sensor. According to some embodiments, the user-activated actuator 102 may be a push button, a lever, or a rotary dial. The user-activated actuator 102 may be configured to open or block one or more water passageways between the water supply inlet portion 101 and the first outlet portion 150 of the second outlet portion 170. According to some embodiments, the user-activated actuator 102 may be located such that a user may reach and activate the user-activated actuator 102 with the same hand that is holding the handle portion 110. In the example of FIG. 1, the user-activated actuator 102 is located on the handle portion 110 such that a user can simultaneously activate the user-activated actuator 102 with one hand and hold the handle portion 110 with the same hand.

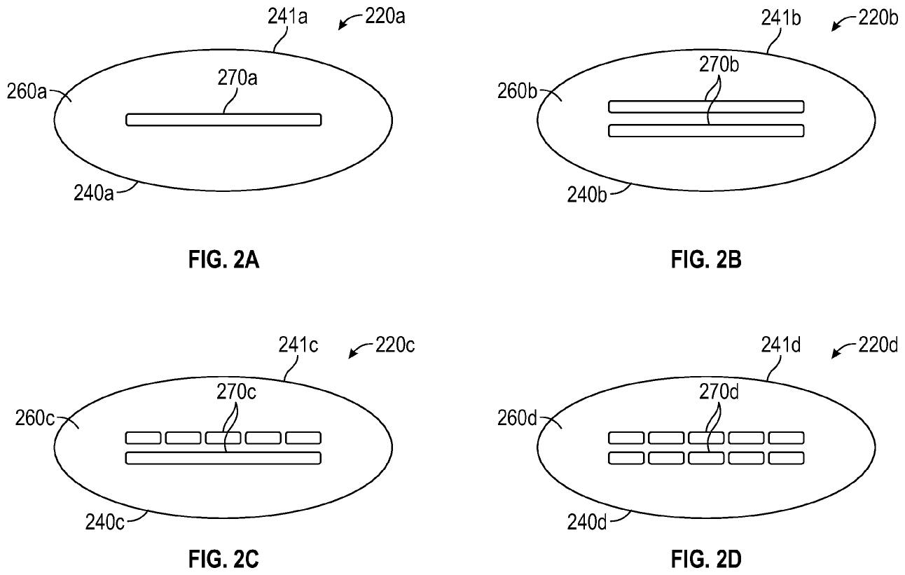

According to some embodiments, one or more of the handle portion and the shower head portion can have a cylindrical shape, such as an elliptical cylindrical shape, a rectangular cylindrical shape, or a circular cylindrical shape. According to some embodiments, a cylindrical shower head that has an elliptical or a rectangular cross-section can be sized to provide a sufficient semi-flat area to deliver a linear sheet-like flow power wash spray having a width of about 10 mm to about 60 mm at the second outlet portion while maintaining a sleek, non-bulky design. FIGS. 2A, 2B, 2C, and 2D respectively show edge views of shower heads 220a, 220b, 220c, 220d that have an elliptical cylindrical shape, according to some embodiments. According to some embodiments, the second outlet portions can include one or more blade nozzles or nozzles configured to deliver a linear sheet-like spray pattern. For example, edge faces 260a, 260b, 260c, 260d of the shower heads 220a, 220b, 220c, 220d respectively include different second outlet portions 270a, 270b, 270c, 270d. In these examples, the second outlet portion 270a includes a single blade nozzle, the second outlet portion 270b includes more than one blade nozzle, and second outlet portion 270c includes different sized nozzles, and second outlet portion 270d includes a plurality of same-sized nozzles. According to some embodiments, the second outlet portions can include different nozzle types and different nozzle sizes to achieve the power wash spray that is effective for cleaning hard surfaces. FIGS. 2A, 2B, 2C, and 2D also show locations of the shower faces 240a, 240b, 240c, 240d and back faces 241a, 241b, 241c, 241d opposite the shower faces 240a, 240b, 240c, 240d of the shower heads 220a, 220b, 220c, 220d.

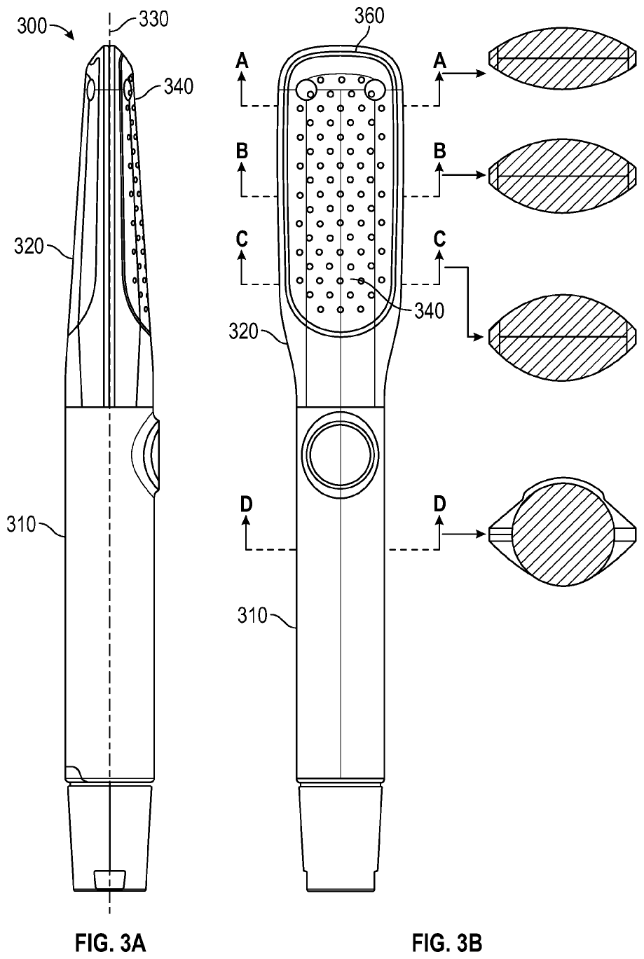

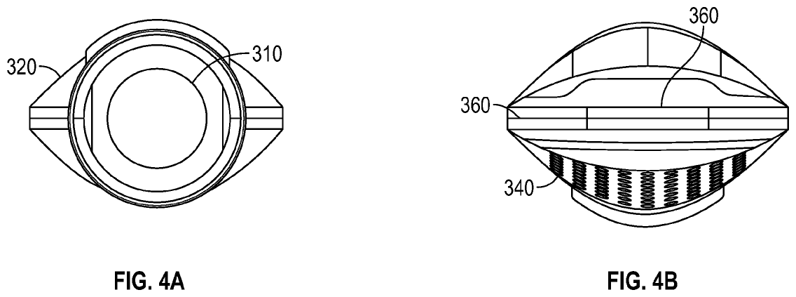

According to some embodiments, the shower head portion may have a more elongated cross-sectional area than a cross-sectional area of the handle portion. According to some embodiments, the hand shower may include a gradual change in cross-sectional area along the longitudinal axis of the hand shower. FIG. 3A shows a side view of an exemplary hand shower 300 and FIG. 3B shows a front view and four exemplary cross-sectional views of the hand shower 300, according to some embodiments. As shown in the example of FIG. 3B, the shower head portion 320 has a cross-sectional area (for example, view A-A, B-B, and C-C) that is more elongated in a direction perpendicular to the longitudinal axis 330 of the hand shower 300 than a cross-section area (for example, view D-D) of the handle portion 310. FIG. 4A illustrates a bottom view of the exemplary hand shower 300 that shows a difference in shape between the handle portion 310 and the hand shower portion 320. In the example of FIG. 4A, the handle portion 310 includes a more circular cross-section than the shower head portion 320

According to some embodiments, the shower head portion 320 includes a shower face 340 for delivering a shower spray as described above in reference to shower face 140 and an edge face 360 for delivering a power wash spray as described above in reference to edge face 160. The edge face 360 may have a smaller area than an area of the shower face 340. The edge face 360 may be shaped to accommodate one or more blade nozzles. FIG. 4B shows a top view of the hand shower 300, according to some embodiments. Comparison of the top view of FIG. 4B and a front view of FIG. 3B, shows that the edge face 360 has a smaller area relative to the shower face 340, according to some embodiments. According to some embodiments, the hand shower 300 may be configured to include different nozzle types on the smaller area of the edge face 360 compared to the larger area of the shower face 340 for delivering the power wash spray from the edge face 360 and the shower spray from the shower face 340.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A hand shower comprising:
an inlet portion for connecting the hand shower to a water supply;
a handle portion;
a shower head portion attached to the handle portion, the shower head portion comprising a shower face, a back face opposite the shower face, and an edge face on an end portion of the shower head portion that extends from the shower face to the back face and is opposite the inlet portion;
a first outlet portion of the shower head located on the shower face, the first outlet portion is configured to direct a shower spray in a first direction; and
a second outlet portion of the shower head located on the edge face, the second outlet portion is configured to direct a power wash spray in a second direction different from the first direction for cleaning hard surfaces.

2. The hand shower of claim 1, wherein the end portion comprises a furthermost end of the shower head portion relative to the handle portion.

3. The hand shower of claim 1, wherein the hand shower is configured to deliver 20% to 50% more water pressure across the edge face in a power wash mode compared to water pressure across the shower face in a shower mode.

4. The hand shower of claim 1, wherein the shower head portion is cylindrical.

5. The hand shower of claim 4, wherein the edge face comprises a length of about 5 mm to about 50 mm.

6. The hand shower of claim 1, wherein the shower face comprises a length of about 50 mm to about 120 mm and a width of about 10 mm to about 60 mm.

7. The hand shower of claim 1, wherein the handle portion is cylindrical.

8. The hand shower of claim 1, wherein the shower head portion and the handle portion share a longitudinal axis throughout the hand shower.

9. The hand shower of claim 1, wherein the edge face is rounded.

10. The hand shower of claim 1, wherein the shower head portion has a larger cross-sectional area than the handle portion.

11. The hand shower of claim 1, wherein the first outlet portion comprises a plurality of first nozzles and the second outlet portion comprises one or more second nozzles.

12. The hand shower of claim 11, wherein the one or more second nozzles comprise blade nozzles configured to deliver the power wash spray with a linear sheet-like flow spray pattern.

13. The hand shower of claim 11, wherein the one or more first nozzles comprise a first set of first nozzles that comprise a first shape and a first size, and a second set of first nozzles that comprise a second shape and a second size different from the first shape and the first size.

14. The hand shower of claim 1, wherein the hand shower is configured to deliver the shower spray or the power wash spray based on actuation of a user-activated actuator.

15. The hand shower of claim 14, wherein the user-activated actuator is configured to open or block one or more water passageways to the first outlet portion or the second outlet portion for delivering the power wash spray or the shower spray.

16. The hand shower of claim 14, wherein the user-activated actuator comprises a capacitive touch sensor.

17. The hand shower of claim 14, wherein the user-activated actuator comprises a push button.

18. The hand shower of claim 14, wherein the user-activated actuator is positioned on the handle portion.

19. The hand shower of claim 1, wherein the second direction is angled between about 45 to about 135 degrees relative to first direction.

20. The hand shower of claim 1, wherein water pressure of the shower spray is from about 45 psi to about 80 psi based on a water supply pressure of about 30 psi to about 80 psi.
